(19) United States
(12) Patent Application Publication
(10) Pub. No.: US 2004/0166482 A1
(43) Pub. Date: Aug. 26, 2004

(54) Four-dimensional gyroscope, demonstrating the violation of the momentum conservation law during the absolute electic collision with the wall

(76) Inventor: Guennady Shipov, Moscow (RU)

Correspondence Address: Gerald S. Geren, LEE, MANN, SMITH, MCWILLIAMS,, SWEENEY & OHLSON, P.O. Box 2786, Chicago, IL, 60690-2786, US

(21) Appl. No.: 09/784,755

(22) Filed: Feb. 15, 2001

(30) Foreign Application Priority Data
Aug. 8, 2000 (TH) 059557

(51) Int. Cl. G09B 23/08

(52) U.S. Cl. 434/302

(57) ABSTRACT

The device is a four-dimensional gyroscope, demonstrating the connection between the translational and the rotational inertia, which leads to the violation of the Momentum Conservation Law of the center of masses during its absolute elastic collision with the wall. For the proof of the violation of one of the basic Laws of Classic Mechanics the device is equipped with the scientific-research complex, that allows to observe double, triple, etc collisions of the four-dimensional gyroscope, as well as to perform comparison of the theoretical calculations with the experimental data.

### BACKGROUND OF THE INVENTION

1. Field of the Invention.

Herewith it is stated the invention of the device, which demonstrates the violation of the momentum conservation law of the center of masses of the Mechanical system. This violation is happening due to the existing connection inside the device between the translational and rotational inertia. In four dimensional space of the theory of special relativity the translational acceleration is viewed as rotation in space-time planes, that is why the invented device was named as “four-dimensional gyroscope”.

2. Description of the Prior Art

The classical mechanics knows two types of the inertia of the object: translational inertia of Galileo-Newton's, the analytical expression of which is the first law of Newton's mechanics m\overline{α}=0 (where m—mass and \overline{α}—acceleration of the object) and the rotational inertia of Newton-Euler's the analytical expression of which is the first law of Newton-Euler's mechanics J\overline{ω}=0 (where J—moment of inertia and \overline{ω}—angular velocity of the rotation of the object). In the classical mechanics it was accepted that these two types of inertia are exist additively and have no connection between them. The present invention provides four-dimensional gyroscope, which establishes such connection both in the theory and in the experiments.

The phenomenon of the inertial-mechanics is one of the most complex and not sufficiently researched problems. Experimentally in the accelerated frames we observe four types of inertia forces:

The centrifugal force \overline{F}₁=−m[\overline{ω}[\overline{ω}\overline{r}]],

The Coriolis force, \overline{F}₂32 −2m[\overline{ω}\overline{v}],

Inertia force, concerned with rotational acceleration \overline{F}₃=−m[\overline{ω}\overline{r}];

As well as translational inertia force \overline{F}₄=−m\overline{W}.

The first 3 forces are caused by the rotation of the object at 3 space angles, because they depend upon the vector of the angular velocity of the rotation \overline{ω}. If we rely on the concept of the special theory of relativity, then the fourth inertia force is created by the rotation as well—the rotation in the three pseudo-euclidean angles. For example, if the object moves with the acceleration along the axis x, then its acceleration is defined through the pseudo-euclidean angle θ in the ct−x plane according to the formula W=v=cd(tan θ)/dt.

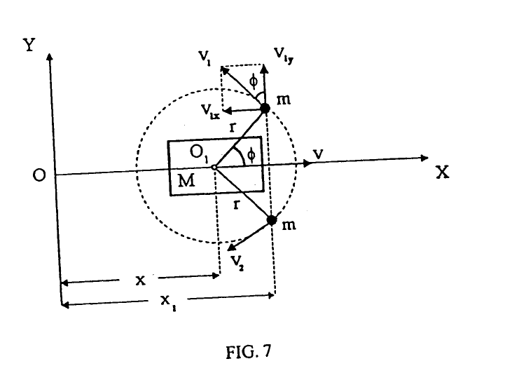

Such concept of the inertia forces allows creating a four-dimensional gyroscope, which rotates not only at the space angles but also at the space-time ones. The principle scheme of the simplest four-dimensional gyroscope is shown below on the FIG. 7

[image]

The base of the device is the mass Min the center of which there is an axis O₁. At the distance r two small masses m are synchronously rotating in the different directions around the axis. In the present model these masses are rotating at the different heights in order to avoid a collision between them. If we start to rotate masses m, the central mass M will begin to oscillate with the fixed amplitude around the common center of masses. As a result we have got the simplest type of four dimensional gyroscope with the rotation at one-dimensional angle φ (rotation of masses m) and the rotation at one space-time angle 8 (translational acceleration of masses M along axis x).

The theoretical description of the proposed four-dimensional gyroscope is based on its translational

(M+2m)v_{c}=(M+2m)v−2mrω sin φ−2mrω² cos φ=0

and rotational

$$J ω - J {k}^{2} \frac{sin φ \cdot cos φ}{1 - {k}^{2} \cdot {sin}^{2} φ} \cdot {ω}^{2} = 0 , J = 2 m {r}^{2}$$

equations of motion, where v_{c}—velocity of the center of the mass of the gyroscope, v—velocity of mass M,ω=φ—angular velocity of the rotation of masses m.

The solution of the translational equation proves that the center of the masses of the system is at rest or in uniform motion due to laboratory reference frame.

The four-dimensional gyroscope has got five energies:

1. Translational energy E=(M+2m)v²/2;

2. Rotational energy W=Jω²/2;

3. The energy of the interaction between translational and rotational inertia H=−2mrvω·sin φ;

4. Total energy T=E+W+H=const and

5. Energy of the center of the masses E_{c}=(M+2m)v_{c}²/2=const, which does not coincide with the total energy

Besides it has got four momentum acting along its axis x:

1. Translational momentum P=(M+2m)v;

2. Rotational momentum L=−2mrω·sin φ;

3. Total momentum C=P+L=const and

4. Momentum of the center of the masses P_{c}=(M+2m)v_{c}=const, corresponding with the complete momentum of the system C=P_{c}.

During the elastic collision of the four-dimensional gyroscope with the wall the following Conservation Laws are taking place:

A. Total energy

T=E+W+H=E′+W′+H′=T′=const

B. Linear momentum

P=(M+2m)v=(M+2m)v′=P′=const.

Besides, during the time of the collision there is one condition takes place:

φ=φ′.

Here the hachures indicate the denotations of the values after the collision. Joint solution of three equation system shows that the velocity of the center of the masses of the four-dimensional gyroscope changes after the collision in accordance with formula

v_{c}′=−v_{c}(1−2(k·sin φ)^{2]-}2Bω·sin φ[1−(k·sin φ)²], (1)

where B=2mr/(M+2m), k²=B/r. Simultaneously after the stroke the angular velocity of rotation is changing according to the formula

$${ω}^{′} = ω [ 1 - 2 {( k \cdot sin φ )}^{2} ] - 2 \cdot sin φ \frac{{v}_{c}}{r} ; \qquad ( 2 )$$

The formulas (1) and (2) show that during the absolute elastic stroke the four-dimensional gyroscope is able to transform the inner rotational energy into the translational energy of the center of the masses and vice versa. That is why after the collision the four-dimensional gyroscope can continue its motion backwards towards the wall and perform the second, third, etc. collisions with the wall. The multiple bounces will be occurring until the time when the velocity of the center of the masses changes its direction into opposite one a 11d the mass M departs from the wall to a distance bigger than B.

### SUMMARY OF THE INVENTION

We claim the invention of the simplest type of four-dimensional Horoscope with the rotation at one space angle φ (rotation of masses m) as well as at one space-time angle θ=arctan (v/c), where v—is the speed of the translational motion of mass M with the fixed axis; and c—is the speed of light. During the absolute elastic collision with the wall, in our case measured by 0.001 sec, the device is demonstrating the violation of one of the basic laws of mechanics—momentum conservation law of center of masses. In order to prove experimentally that the evidence of this statement, besides four-dimensional gyroscope there was organized the scientific research center, which allowed the following:

To visually observe the double, triple, etc. absolutely elastic collisions of four-dimensional gyroscope with the wall;

Before and after the collision to register automatically such kinematic characteristics of four dimensional gyroscope as:

1. Coordinate x(t) mass M;

2. Coordinate X_{c}(t) of the center of masses;

3. The rotation angle φ.

With the help of computer programs to -calculate before and after the collision the following:

1. Velocity v(t) of mass M;

2. Velocity v_{c}(t) of the center of masses;

3. Angular velocity m(t);

4. Acceleration A(t) of mass M;

5. Acceleration A_{c}(t) of the center of masses;

6. Angular acceleration K(t).

To prove the correctness of the formulas according to the obtained data.

### BRIEF DESCRIPTION OF THE DRAWINGS DESCRIPTIONS OF THE PREFERRED EMBODIMENTS

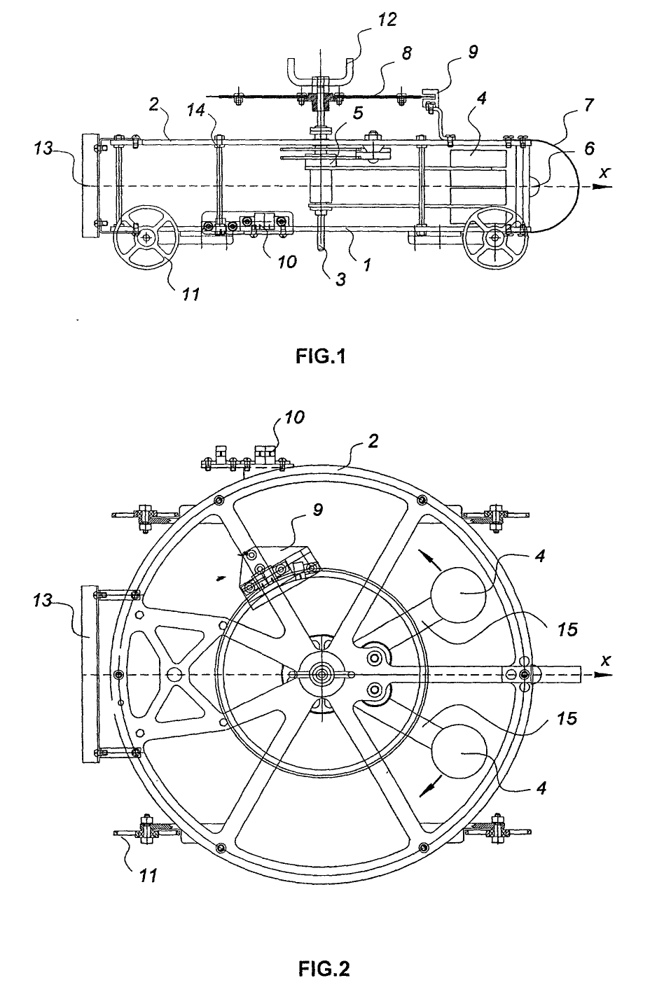

The FIG. 1 represents the general view of the four-dimensional gyroscope along the axis of symmetry, the colliding part, the measuring blocks and the supporting wheels.

The FIG. 2 depicts the top view with the small masses m allocated symmetrically along the axis of symmetry x.

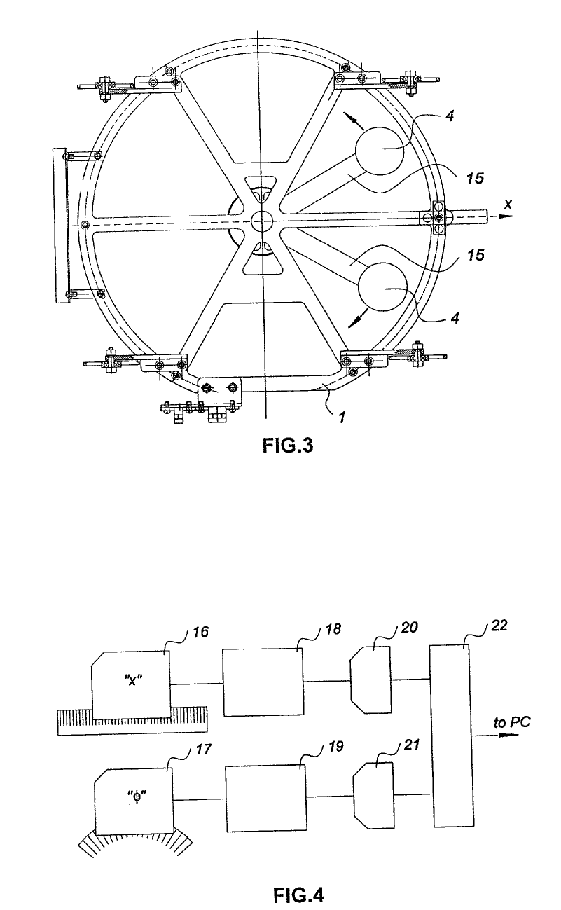

The FIG. 3 depicts the view from the beneath with the adjustments for the wheels and registration equipment.

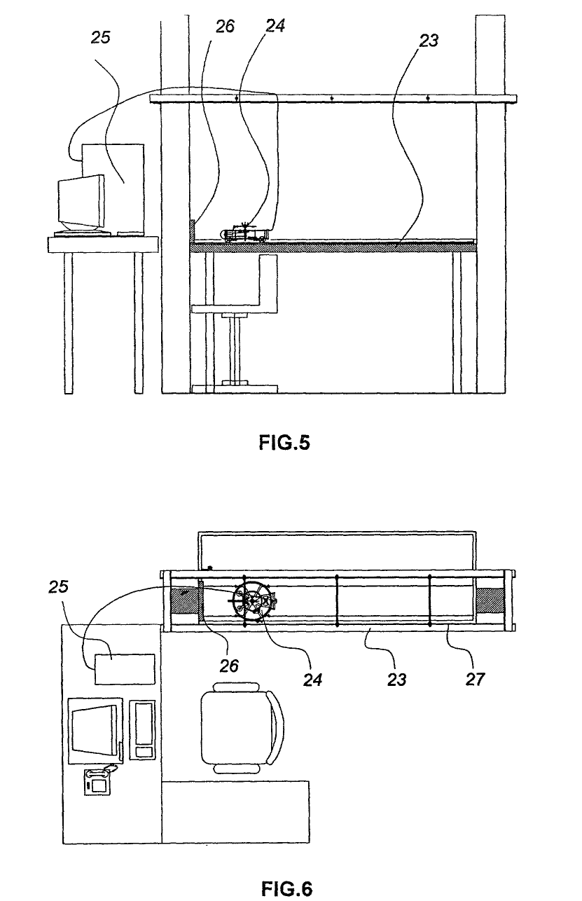

The FIG. 4 adduces the drawing of the whole complex, registrating the kinematic characteristics of the four-dimensional gyroscope.

The FIG. 5 the block-scheme for the research center of the absolute elastic collision of the four-dimensional gyroscope.

The FIG. 6. the same view, but from the top.

The FIG. 7 depicts the principle scheme of the four-dimensional gyroscope.

### THE DESCRIPTION OF THE PREFERRED EMBODIMENTS

The FIG. 1 represents the general view of the four-dimensional gyroscope. The lower part 1 and the upper part 2 of the gyroscope body are made from aluminum and connected together with help of the steel studs 14. The central shaft 3 has got the differential mechanism 5, which synchronously rotates small masses 4 in the different directions. The technological handle 12 starts the rotation. As soon as small masses begin rotation, the device 24 moves forward with a certain speed towards metal wall 26 (FIG. 5 alld 6). The motion of gyroscope 24 (FIG. 5, 6) is investigated on the horizontal surface 23 (FIG. 5), verified with precision. At the moment of the collision with the wall the spring stud 7, secured by the hard stud 6, pounces. During the motion of four-dimensional gyroscope before and after the collision the measurements of the angles φ of the rotation are registered with the help of the polar ruler 8 and photo-elements 9. The notations of coordinate x(t) are registered synchronously with the help of the photo-elements 10. The data from the photo-elements transferred to the reformatting block 13 (FIG. 2), schematically drafted on FIG. 4. The signals from the photoelements 16 and 17 are sent to the amplifiers 18 and 19 (FIG. 4) then to the Analog Digital CO11 verters 20 and 21. After ADC the signal, transformed into O and I, is sent to the transmitter 22, which the latter sends to the computer 25 (FIG. 5.6) for further calculations. The software program allows monitoring the kinematic parameters of the four-dimensional gyroscope before and after the collision in real time.

What is claimed is:

1. The device for the demonstration the violation of the momentum conservation law of the center of masses during its absolute elastic collision with the wall consists of the following:
A. Mass M, which is formed by the lower 1 and upper 2 parts of the body, the elements 3, 5, 6-13 as well as the body itself;
B. Small masses 4, rotating synchronously into different directions and creating the rotation inertia;
C. Body M, which moves together with the rotating small masses 4 along the axis x and creating the translational inertia;
D. The axis of rotation 3 of the small masses 4, fixed on the body M, moving translational, which provides the connection between the translational and rotational inertia.

2. The device of claim 1 which says that with the motion of the parts of the device the rotational inertia is transformed into translational inertia and vice versa.

3. The device of claim 2 which says that when the external force is absent both translational and rotation inertia are balanced, so. that the center of the whole system is at rest or moves linear and uniformly.

4. The device of claim 3 which says that the external force acting on the device along its axis x changes its translational inertia that violates the balance between the translational and rotation inertia, and the center of masses changes its velocity.

5. The device of claim 4 which says that when the external force stops its effect along the axis x, the rotational and translational inertia are redistributed inside the device until they balance each other, afterwards the center of masses begins to move with new constant velocity

6. The device of claim 5 which says that during the effect of the external force the new velocity of the center of the masses depends not only upon the value of the external effect, but also upon the angle of the disposition of the smaller masses relatively the axis x as well as upon the value of the angular velocity.

7. The device of claim 6 which says that during the absolute elastic collision of the device with the wall the velocity of the center of the masses changes not only its direction after the collision but also absolute value according to the formula (1)

8. The device of claim 7 which:
A. Demonstrates the violation of the momentum conservation law of the center of the masses during the absolute elastic collision.
B. Allows to produce the “inner impact”, which changes the velocity of the center of the masses of the system without external effect, by changing the angular velocity of the rotation of the small masses inside the system.
C. During the absolute elastic collision can perform the multiple collisions with the wall before the final bounce.
